(19) United States
(12) Patent Application Publication
(10) Pub. No.: US 2019/0251355 A1
(43) Pub. Date: Aug. 15, 2019

(54) METHOD AND ELECTRONIC DEVICE FOR GENERATING TEXT COMMENT ABOUT CONTENT

(71) Applicant: SAMSUNG ELECTRONICS CO., LTD., Suwon-si (KR)

(72) Inventors: Hyungtak CHOI, Suwon-si (KR); Inchul HWANG, Suwon-si (KR); Hyeonmok KO, Suwon-si (KR); Hongchul KIM, Suwon-si (KR)

(21) Appl. No.: 16/266,217

(22) Filed: Feb. 4, 2019

(30) Foreign Application Priority Data
Feb. 9, 2018 (KR) 10-2018-0016559

(51) Int. Cl. G06K 9/00; G06F 17/24; G06F 16/587; G06F 16/583; G06N 3/02

(52) U.S. Cl. CPC G06K 9/00671; G06F 17/241; G06N 3/02; G06F 16/5854; G06F 16/587

(57) ABSTRACT

Provided are an artificial intelligence (AI) system that mimics functions, such as recognition and determination, of the human brain, utilizing a neural network model, such as deep learning, and applications of the AI system. A method of generating a text comment about content includes obtaining a content group including one or more items of content, obtaining feature information of each of the one or more items of content, determining focus content from among the one or more items of content using the obtained feature information, generating a text comment about the content group using the focus content, and displaying the generated text comment.

### CROSS-REFERENCE TO RELATED APPLICATION

This application is based on and claims priority under 35 U.S.C. § 119 to Korean Patent Application No. 10-2018-0016559, filed on Feb. 9, 2018, in the Korean Intellectual Property Office, the disclosure of which is incorporated by reference herein in its entirety.

### BACKGROUND

### 1. Field

The disclosure relates to a method and electronic device for automatically generating a text comment about at least one item of content.

### 2. Description of Related Art

Artificial intelligence (AI) systems are computer systems configured to realize human-level intelligence and train themselves and make determinations spontaneously to become smarter, in contrast to existing rule-based smart systems. Because recognition rates of AI systems improve and the AI systems more accurately understand a user's preferences the more they are used, existing rule-based smart systems are being gradually replaced by deep-learning AI systems.

AI technology includes machine learning (deep learning) and element technologies employing the machine learning.

Machine learning may refer to an algorithm technology that self-classifies/learns the characteristics of input data, and each of the element technologies is a technology of mimicking functions of human brains, such as perception and determination, using a machine learning algorithm, such as deep learning, and includes technical fields, such as linguistic understanding, visual understanding, deduction/prediction, knowledge representation, and operation control.

Various fields to which AI technology is applied are as follows. Linguistic understanding may refer to a technique of recognizing a language/character of a human and applying/processing the language/character of a human, and includes natural language processing, machine translation, a conversation system, questions and answers, voice recognition/synthesis, and the like. Visual understanding may refer to a technique of recognizing and processing an object like in human vision, and includes object recognition, object tracking, image search, human recognition, scene understanding, space understanding, image improvement, and the like. Deduction/prediction may refer to a technology of logically performing deduction and prediction by determining information, and includes knowledge/probability-based deduction, optimization prediction, a preference-based plan, recommendation, and the like. Knowledge representation may refer to a technique of automatically processing human experience information as knowledge data, and includes knowledge establishment (data generation/classification), knowledge management (data utilization), and the like. Operation control may refer to a technique of controlling autonomous driving of a vehicle and motions of a robot, and includes motion control (navigation, collision avoidance, and driving), manipulation control (behavior control), and the like.

Electronic devices can transmit a social network service (SNS) message including various types of content, such as one or more pictures or moving pictures and audio, to an SNS system according to a user input. In this case, electronic devices can transmit a text comment for representing content or as an additional description related to the content, together with the content. The text comment may be written according to a direct input of a user. However, for user convenience, electronic devices need to automatically generate the text comment and provide the generated text comment to the user.

### SUMMARY

Embodiments of the present disclosure provide methods and electronic devices for automatically generating a text comment about one or more items of content.

Additional aspects will be set forth in part in the description which follows and, in part, will be apparent from the description.

According to an embodiment of the disclosure, a method of generating a text comment about content includes obtaining a content group including one or more items of content; obtaining feature information of each of the one or more items of content; determining focus content from among the one or more items of content using the obtained feature information; generating a text comment about the content group using the focus content; and displaying the generated text comment.

According to another embodiment of the disclosure, an electronic device for generating a text comment about content includes a processor configured to control the electronic device to: obtain a content group including one or more items of content, obtain feature information of each of the one or more items, determine focus content from among the one or more items of content using the obtained feature information, and generate a text comment about the content group using the focus content; and a display configured to display the generated text comment.

According to another embodiment of the disclosure, a non-transitory computer-readable recording medium has recorded thereon a computer program, which, when executed by a computer (or processor), performs the above-described method.

### BRIEF DESCRIPTION OF THE DRAWINGS

The above and other aspects, features, and advantages of certain embodiments of the disclosure will be more apparent from the following detailed description, taken in conjunction with the accompanying drawings, in which:

FIG. 1 is a diagram illustrating an example of automatically generating a text comment about one or more items of content, according to an embodiment of the disclosure;

FIG. 2 is a block diagram illustrating an example electronic device according to an embodiment of the disclosure;

FIG. 3 is a block diagram illustrating an example electronic device according to an embodiment of the disclosure;

FIG. 4 is a block diagram illustrating an example processor according to an embodiment of the disclosure;

FIG. 5 is a block diagram illustrating an example data trainer according to an embodiment of the disclosure;

FIG. 6 is a block diagram illustrating an example data recognizer according to an embodiment of the disclosure;

FIG. 7 is a block diagram illustrating an example where the electronic device and a server interoperate to train and recognize data, according to an embodiment of the disclosure;

FIG. 8 is a flowchart illustrating an example method of generating a text comment about content, according to an embodiment of the disclosure;

FIG. 9 is a flowchart illustrating an example method of generating a text comment about content, according to an embodiment of the disclosure; and

FIG. 10 is a block diagram illustrating an example method of generating a text comment about content, according to an embodiment of the disclosure.

### DETAILED DESCRIPTION

Throughout the disclosure, the expression “at least one of a, b or c” may indicate only a, only b, only c, both a and b, both a and c, both b and c, all of a, b, and c, or variations thereof.

Embodiments of the disclosure are described in greater detail herein with reference to the accompanying drawings so that this disclosure may be easily understood by one of ordinary skill in the art to which the disclosure pertains. The disclosure may, however, be embodied in many different forms and should not be understood as being limited to the embodiments of the disclosure set forth herein. In the drawings, parts irrelevant to the description may be omitted for simplicity of explanation, and like numbers refer to like elements throughout.

Throughout the disclosure, when an element is referred to as being “connected” or “coupled” to another element, it can be directly connected or coupled to the other element, or can be electrically connected or coupled to the other element with intervening elements interposed therebetween. In addition, the terms “comprises” and/or “comprising” or “includes” and/or “including” when used in this disclosure, specify the presence of stated elements, but do not preclude the presence or addition of one or more other elements.

The disclosure will now be described more fully with reference to the accompanying drawings, in which various example embodiments of the disclosure are shown.

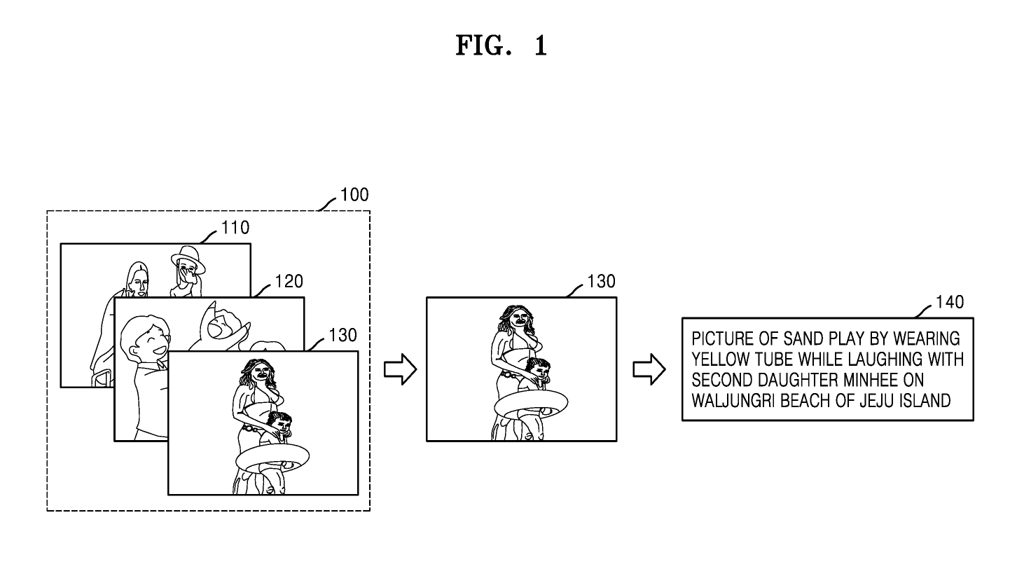

FIG. 1 is a diagram illustrating an example of automatically generating a text comment about one or more items of content, according to an embodiment of the disclosure.

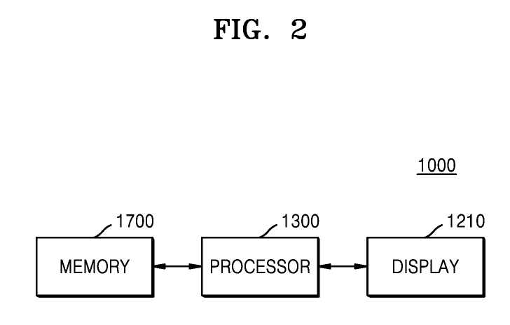

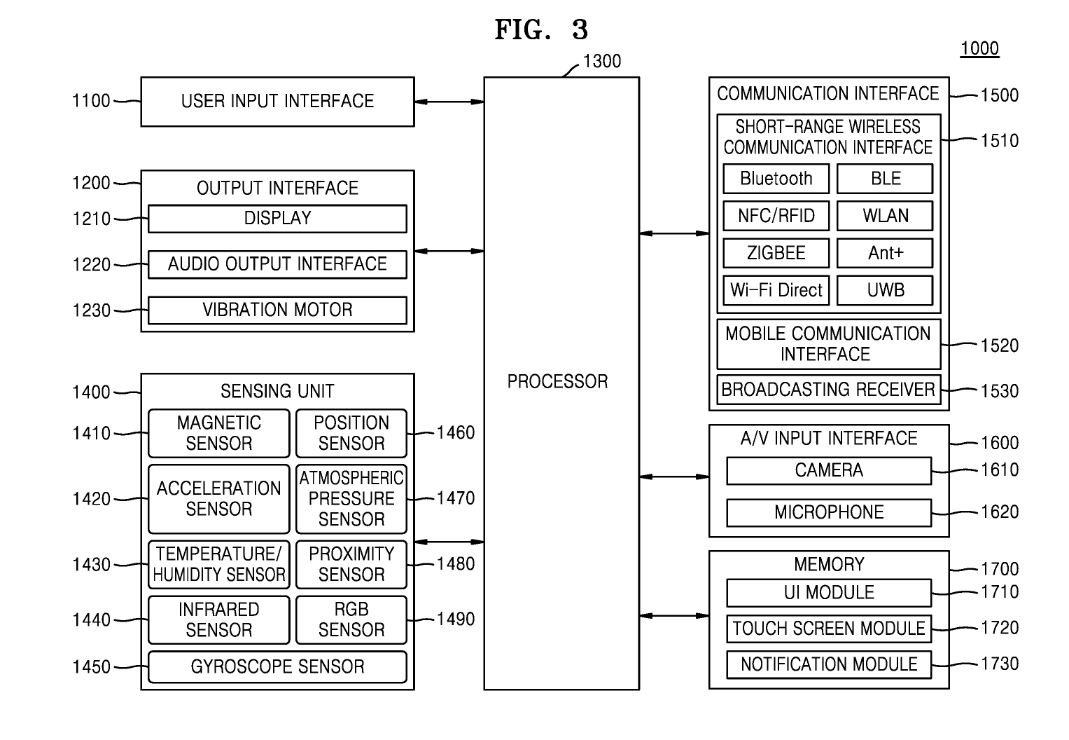

Referring to FIG. 1, an electronic device 1000 (see, e.g., FIGS. 2 and 3) according to an embodiment of the disclosure may generate a text comment 140 about a content group 100 including one or more items of content 110, 120, and 130. For example, the electronic device 1000 may determine focus content 130 from among the one or more items of content 110, 120, and 130, and may generate a text comment about the content group 100 including the one or more items of content 110, 120, and 130 using the focus content 130.

The one or more items of content 110, 120, and 130 according to an embodiment of the disclosure may include various types of content, such as, for example, and without limitation, an image, a moving picture, a voice, a text, multimedia, or the like. The one or more items of content 110, 120, and 130 according to an embodiment of the disclosure may include content generated by the electronic device 1000, but embodiments of the disclosure are not limited thereto. The one or more items of content 110, 120, and 130 may include content received from an external device.

The electronic device 1000 according to an embodiment of the disclosure may write a notice including the one or more items of content 110, 120, and 130 and the text comment 140, based on a user input, and may upload the written notice on, for example, and without limitation, social network services (SNSs), Internet bulletin boards, blogs, or the like. The electronic device 1000 according to an embodiment of the disclosure may write an SNS message or an E-mail message including the one or more items of content 110, 120, and 130 and the text comment 140, based on a user input, and may transmit the written SNS message or E-mail message to an external device, but embodiments of the disclosure are not limited to the above-described example, and the electronic device 1000 may generate various types of content using the one or more items of content 110, 120, and 130 and the text comment 140. The text comment 140 generated according to an embodiment of the disclosure may be corrected based on a user input, and then may be used to write various types of content, such as the aforementioned notice and message.

The text comment according to an embodiment of the disclosure may include a text explaining the one or more items of content 110, 120, and 130 or indicating information related to the one or more items of content 110, 120, and 130, as a text related to the one or more items of content 110, 120, and 130, but embodiments of the disclosure are not limited to the above-described example, and the text comment according to an embodiment of the disclosure may include various contents of texts related to the one or more items of content 110, 120, and 130.

The focus content 130 according to an embodiment of the disclosure may be determined based on feature information about each of the one or more items of content 110, 120, and 130. For example, content including the most pieces of feature information common to the one or more items of content 110, 120, and 130 may be determined as the focus content 130.

As another example, the focus content 130 may be determined based on a central theme of a text comment, which is input by a user. For example, content including the most pieces of feature information highly related to the central theme of the text comment input by the user may be determined as the focus content 130.

As another example, the focus content 130 may be determined according to a machine learning algorithm previously trained to select the focus content 130. For example, the aforementioned machine learning algorithm may be included in a data recognition model for generating a text comment according to an embodiment of the disclosure, but embodiments of the disclosure are not limited to the above-described example, and the machine learning algorithm for selecting the focus content 130 may exist separate from the data recognition model for generating a text comment.

As another example, the focus content 130 may be determined based on a user input of directly selecting the focus content 130. Embodiments of the disclosure are not limited to the above-described example, and the focus content 130 may be determined according to various other methods.

According to an embodiment of the disclosure, the text comment 140 may be generated using the focus content 130 determined from among one or more items of content 110, 120, and 130. For example, the text comment 140 may be generated by preferentially using the feature information of the focus content 130 as opposed to the respective pieces of feature information of the items of content 110 and 120 except for the focus content 130. According to an embodiment of the disclosure, the electronic device 1000 may generate a text comment about the one or more items of content 110, 120, and 130 by preferentially using the feature information of the focus content 130 from among the respective pieces of feature information of the one or more items of content 110, 120, and 130.

When a text comment is generated according to feature information of a plurality of items of content, respective pieces of feature information of the plurality of items of content may overlap with or be contradictory to each other, and thus a text comment including awkward or contradictory contents may be generated. However, according to an embodiment of the disclosure, a text comment is generated based on focus content determined from among one or more items of content, and thus the text comment may be generated according to neither overlapping nor contradictory feature information.

According to an embodiment of the disclosure, the electronic device 1000 may generate a text comment by further using the pieces of feature information of the other items of content 110 and 120 that are not overlapped with or not contradictory to the feature information of the focus content 130, while using the feature information of the focus content 130. For example, the electronic device 1000 may determine first content having feature information overlapped with or contradictory to feature information of focus content from among one or more items of content. The electronic device 1000 may generate a text comment by further using second content other than the first content from among the one or more items of content.

The feature information of each of the one or more items of content 110, 120, and 130 according to an embodiment of the disclosure may include various types of information representing the features of the content. For example, the feature information may include, for example, and without limitation, at least one of information about an object included in the content, weather and a location related to the content, information about a user, or the like.

The object included in the content according to an embodiment of the disclosure may be recognized based on a machine learning algorithm for recognizing the object included in the content. The machine learning algorithm for recognizing the object may be included in the data recognition model for generating a text comment according to an embodiment of the disclosure, but embodiments of the disclosure are not limited to the above-described example, and the machine learning algorithm for recognizing the object may exist separate from the data recognition model for generating a text comment.

According to an embodiment of the disclosure, the object included in the content may be recognized based on location information corresponding to the content. For example, when an A restaurant and a B statue exist at a location where the content is photographed, it is highly likely that at least one of the A restaurant and the B statue is included in the content. Accordingly, the electronic device 1000 may recognize, as the object, at least one of the A restaurant and the B statue included in the content, based on location information about the location where the content is photographed.

The object included in the content according to an embodiment of the disclosure may be recognized based on a user input for designating a region including the object. Embodiments of the disclosure are not limited to the above-described example, and the object included in the content may be recognized according to various other methods. The object included in the content may include various types of targets that may be recognized from the content, such as not only human but also, for example, and without limitation, animals, objects, places, or the like.

The information about the object included in the content according to an embodiment of the disclosure may include various pieces of information related to the object, such as, for example, and without limitation, identification (ID) information of the object, location information of the object, information about a status of the object, information about features of the object, or the like.

The ID information of the object may include information for identifying the object, such as, for example, and without limitation, information about the title of the object, the type thereof, or the like. According to an embodiment of the disclosure, the ID information of the object may be obtained based on user data of the electronic device 1000.

The user data may include information related to the user, such as, for example, and without limitation, a surrounding environment of the user, surrounding people thereof, a life pattern thereof, or the like. The user data may be obtained based on at least one of information sensed by a sensor and information input by the user. For example, the user data may include a life log of the user related to one or more items of content. The life log of the user may include information about the daily life of the user, wherein the information may be collected by the electronic device 1000. For example, the life log may include various pieces of information related to the user, such as, for example, and without limitation, whether the user does exercises, a movement state of the user, places the user visited, or the like.

For example, the user data may include information about people, objects, and animals related to the user of the electronic device 1000. When one person from among the family members of the user is recognized as an object in content, the electronic device 1000 may obtain a title (e.g., my daughter, a son, and my mother) of the recognized object as ID information of the recognized object, based on the user data.

The location information of the object may include information about a geographical location where the object is present. According to an embodiment of the disclosure, the location information of the object may be obtained based on location information related to the content (e.g., location information of the electronic device 1000 when the content is photographed).

For example, the electronic device 1000 may obtain the number of times the user visited the geographical location where the object is present, using location recording information of the user data and the location information of the object. For example, when a location of the object included in the content is ‘the Waljungri beach of Jeju island’ and the user revisits ‘the Waljungri beach of Jeju island’ in three years to photograph the content, the electronic device 1000 may obtain ‘the Waljungri beach of Jeju island revisited in three years’ as feature information of the content.

The information of the state of the object may include, for example, and without limitation, information about an action, an emotion, a facial expression, and the like, of the object. The information of the state of the object may be obtained according to a machine learning algorithm for determining the state of the object. The machine learning algorithm for determining the state of the object may be included in the data recognition model for generating a text comment according to an embodiment of the disclosure. However, embodiments of the disclosure are not limited thereto, and the machine learning algorithm for determining the state of the object may exist separately from the data recognition model for generating a text comment.

The information about the features of the object may be obtained based on, for example, and without limitation, at least one of information obtained via Internet searching using a keyword related to the object recognized by the electronic device 1000, the user data, or the like.

The keyword related to the object recognized by the electronic device 1000 may be determined based on the title of the recognized object. For example, when the recognized object is the A restaurant, the electronic device 1000 may obtain the title of the A restaurant, based on the above-described location information of the content. The electronic device 1000 may obtain information about features about the A restaurant, by performing Internet searching using the title of ‘the A restaurant’.

As another example, the electronic device 1000 may obtain feature information of the A restaurant, based on user data about the A restaurant. For example, the feature information of the A restaurant may be obtained based on various types of user data, such as information about the A restaurant input by the user and the number of times the user visited the A restaurant.

According to an embodiment of the disclosure, the electronic device 1000 may generate a text comment including, for example, and without limitation, at least one of ID information, location information, state information, feature information, or the like, of an object included in the focus content 130.

According to an embodiment of the disclosure, when the user of the electronic device 1000 is recognized as an object in the content, the electronic device 1000 may generate the text comment in a first-person expression.

Information about a user related to content according to an embodiment of the disclosure may include information about an action state (e.g., in motion or being resting) of the user of the electronic device 1000 during content generation. In the case of content generated by an external device, action information of the content may include information about an action state of a user who uses the external device. The information about the action state of the user may be obtained based on information sensed by various types of sensors, such as an acceleration sensor, an infrared sensor, and a position sensor included in the electronic device 1000. Embodiments of the disclosure are not limited to the above-described example, and the information about the action state of the user may be obtained based on various types of information.

According to an embodiment of the disclosure, the electronic device 1000 may generate a text comment using information about a user related to the focus content 130. For example, the electronic device 1000 may generate a text comment including an expression representing an action state (e.g., moving via a bus/subway) of the user.

Location information of content according to an embodiment of the disclosure may include information about a geographical location of the electronic device 1000 when the electronic device 1000 generates the content. The location information about the content may be obtained based on information sensed by the position sensor included in the electronic device 1000.

According to an embodiment of the disclosure, the electronic device 1000 may generate a text comment using location information of the focus content 130. For example, the electronic device 1000 may generate a text comment including an expression representing a location or place where the content is photographed (e.g., an A beach, a B restaurant, or a C school of Jeju island).

According to an embodiment of the disclosure, weather information of content may include information about weather when the content is generated. The electronic device 1000 may generate a text comment using weather information of the focus content 130. For example, the electronic device 1000 may generate a text comment including an expression representing weather when the focus content 130 is photographed (e.g., a snowy day or a rainy data).

According to an embodiment of the disclosure, the electronic device 1000 may generate a text comment using not only information obtainable as a result of analyzing the focus content 130 but also information obtained via various methods, such as personal information of the user related to the focus content 130 or information searchable on the Internet. Accordingly, the electronic device 1000 according to an embodiment of the disclosure may generate a text comment including a personalized and more detailed expression for representing content.

According to the example embodiment of FIG. 1, to generate the text comment 140, location information related to content and information about an object may be obtained as the feature information of the focus content 130. For example, the location information may include ‘the Waljungri beach of Jeju island’, which is a place where the focus content 130 is photographed. The information about the object may include ‘I (user)’ and ‘the second daughter Minhee’ as ID information of the object recognized by the focus content 130. The information about the object may include ‘I (user) is playing with sand while laughing’ and ‘The second daughter Minhee is playing with sand by wearing a yellow tube’, as information about action states of objects included in the focus content 130. Accordingly, based on the above-described feature information of the focus content 130, the electronic device 1000 may generate the text comment 140 in a first-person expression, which is ‘a picture of a sand play (state information of the object) by wearing a yellow tube while laughing with the second daughter Minhee (ID information of the object) on the Waljungri beach of Jeju island (location information)’.

A text comment according to an embodiment of the disclosure may be generated based on a text template into which feature information is insertable. For example, the text template may include ‘at (location information)’, ‘with (ID information of object)’, and ‘in a state of doing (state information of object)’. The text template may be obtained based on the feature information of the focus content 130. For example, the text template may include at least one phrase into which each feature information is insertable.

The text comment according to an embodiment of the disclosure may be generated based on a generation pattern of a text comment used by the electronic device 1000, based on a user input. According to an embodiment of the disclosure, the generation pattern of the text comment may be trained based on a text comment used to write a notice or message based on a user input, and the one or more items of content 110, 120, and 130 corresponding to the text comment. Accordingly, the electronic device 1000 according to an embodiment of the disclosure may generate a text comment using the generation pattern of the text comment for the user. For example, the electronic device 1000 may generate a text comment according to the number of times the user uses each of a text structure and a word, based on the generation pattern of the text comment.

The generation pattern of the text comment may also be trained by a text comment used by another user other than the user of the electronic device 1000.

The text comment according to an embodiment of the disclosure may be displayed on a display or output via another output means such that a user may check the text comment. Based on a user input, the text comment generated according to an embodiment of the disclosure may be corrected. The text comment may be downloaded as a notice including the one or more items of content 110, 120, and 130 on SNSs, Internet bulletin boards, and blogs, based on a user input. The text comment may be transmitted together with the one or more items of content 110, 120, and 130 to an external device through messages, e-mails, and the like, based on a user input. Based on a user input, the text comment used by the electronic device 1000 may be used when the generation pattern of the text comment is trained.

The electronic device 1000 according to an embodiment of the disclosure may write various types of content using the generated text comment, but may correct content or apply a filter, based on a content writing pattern of the user. For example, when the user is identified as an object in content, the electronic device 1000 may apply a correction filter frequently used by the user to an object identified as the user.

The electronic device 1000 according to an embodiment of the disclosure may determine whether to use the object identified as the user to generate the text comment. For example, when the object is determined to be an entertainer, a public figure, a target going against a social rule or a moral sense, or the like, the electronic device 1000 may not use the above-described information about the object to generate the text comment. Accordingly, the electronic device 1000 according to an embodiment of the disclosure may generate a text comment such that the text comment does not include information about a sensitive or inappropriate object included in content. Therefore, the electronic device 1000 may operate such that an inappropriate text comment is not generated.

FIG. 2 is a block diagram illustrating an example of the electronic device 1000 according to an embodiment of the disclosure. FIG. 3 is a block diagram illustrating an example of the electronic device 1000 according to an embodiment of the disclosure.

Referring to FIG. 2, the electronic device 1000 according to an embodiment of the disclosure may include a memory 1700, a display 1210, and a processor (e.g., including processing circuitry) 1300. All of the components illustrated in FIG. 2 are not essential components of the electronic device 1000. More or less components than those illustrated in FIG. 2 may be included in the electronic device 1000.

For example, as shown in FIG. 3, the electronic device 1000 according to an embodiment of the disclosure may further include a user input interface (e.g., including input circuitry) 1100, a communication interface (e.g., including communication circuitry) 1500, an output interface (e.g., including output circuitry) 1200, a sensing unit (e.g., including at least one sensor and/or sensing circuitry) 1400, and an audio/video (NV) input interface (e.g., including A/V input circuitry) 1600 in addition to the memory 1700, the display 1210, and the processor 1300.

The user input interface 1100 may include various input circuitry via which a user inputs data for controlling the electronic device 1000. For example, the user input interface 1100 may include, for example, and without limitation, one or more of a key pad, a dome switch, a touch pad (e.g., a capacitive overlay type, a resistive overlay type, an infrared beam type, an integral strain gauge type, a surface acoustic wave type, a piezo electric type, or the like), a jog wheel, a jog switch, or the like.

According to an embodiment of the disclosure, the user input interface 1100 may receive a user input for generating a text comment. The user input interface 1100 may receive a user unit for correcting or utilizing a generated text comment.

The output interface 1200 may include various output circuitry and output, for example, and without limitation, an audio signal, a video signal, a vibration signal, or the like, and may include, for example, and without limitation, the display 1210, an audio output interface (e.g., including audio output circuitry) 1220, and a vibration motor 1230.

The display 1210 displays information that is processed by the electronic device 1000. For example, the display 1210 may display one or more items of content from which a text comment is to be generated. The display 1210 may also display a text comment generated according to an embodiment of the disclosure.

When the display 1210 may form a layer structure together with a touch pad to construct a touch screen, the display 1210 may be used as an input device as well as an output device. The display 1210 may include, for example, and without limitation, at least one of a liquid crystal display (LCD), a thin film transistor-liquid crystal display (TFT-LCD), an organic light-emitting diode (OLED), a flexible display, a three-dimensional (3D) display, an electrophoretic display, or the like. According to an embodiment of the disclosure, the electronic device 1000 may include at least two displays 1210.

The audio output interface 1220 may include various audio output circuitry and outputs audio data that is received from the communication interface 1500 or stored in the memory 1700.

The vibration motor 1230 may output a vibration signal. The vibration motor 1230 may also output a vibration signal when a touch screen is touched.

The processor 1300 may include various processing circuitry and typically controls all operations of the electronic device 1000. For example, the processor 1300 may control the user input interface 1100, the output interface 1200, the sensing unit 1400, the communication interface 1500, the A/V input interface 1600, and the like by executing programs stored in the memory 1700.

According to an embodiment of the disclosure, the processor 1300 may obtain a content group including one or more items of content. The processor 1300 may obtain feature information of the one or more items of content included in the content group and may determine focus content from among the one or more items of content using the feature information. The processor 1300 may generate a text comment about the content group using the feature information about the focus content.

The sensing unit 1400 may include various sensing circuitry and/or sensors and sense a state of the electronic device 1000 or a state of the surrounding of the electronic device 1000 and may transmit information corresponding to the sensed state to the processor 1300. According to an embodiment of the disclosure, the information corresponding to the state sensed by the sensing unit 1400 may be obtained as user data related to content and information about users.

The sensing unit 1400 may include, but is not limited thereto, at least one selected from a magnetic sensor 1410, an acceleration sensor 1420, a temperature/humidity sensor 1430, an infrared sensor 1440, a gyroscope sensor 1450, a position sensor (e.g., a global positioning system (GPS)) 1460, a pressure sensor (e.g., atmospheric pressure sensor) 1470, a proximity sensor 1480, and an RGB sensor 1490 (e.g., an illumination sensor).

The communication interface 1500 may include various communication circuitry including at least one component that enables the electronic device 1000 to communicate with a server 2000 or an external device (not shown). For example, the communication interface 1500 may include various communication circuitry included in various modules, interfaces, or the like, and may include, for example, and without limitation, a short-range wireless communication interface (e.g., including short-range wireless communication circuitry) 1510, a mobile communication interface (e.g., including mobile communication circuitry) 1520, and a broadcasting receiver (e.g., including broadcast receiving circuitry) 1530.

Examples of the short-range wireless communication interface 1510 may include, but are not limited to, a Bluetooth communication interface, a Bluetooth Low Energy (BLE) communication interface, a near field communication (NFC) interface, a wireless local area network (WLAN) (e.g., Wi-Fi) communication interface, a ZigBee communication interface, an infrared Data Association (IrDA) communication interface, a Wi-Fi direct (WFD) communication interface, an ultra wideband (UWB) communication interface, and an Ant+ communication interface.

The mobile communication interface 1520 may exchange a wireless signal with at least one selected from a base station, an external terminal, and a server on a mobile communication network. Examples of the wireless signal may include a voice call signal, a video call signal, and various types of data according to text/multimedia messages transmission.

The broadcasting receiver 1530 receives a broadcasting signal and/or broadcasting-related information from an external source via a broadcasting channel. The broadcasting channel may be a satellite channel, a ground wave channel, or the like. According to embodiments of the disclosure, the electronic device 1000 may not include the broadcasting receiver 1530.

The communication interface 1500 according to an embodiment of the disclosure may transmit and/or receive data to and/or from the external device (not shown). For example, the communication interface 1500 may transmit, to an external server, the text comment generated for the one or more items of content together with the one or more items of content, based on a user input. The one or more items of content and the text comment transmitted to the external server may be uploaded as a notice on an SNS, a blog, an Internet bulletin board, and the like. As another example, the communication interface 1500 may transmit, to the external device, the text comment generated for the one or more items of content, together with the one or more items of content, as an SNS message or an E-mail message, based on a user input.

The A/V input interface 1600 may include various A/V input circuitry and inputs an audio signal or a video signal, and may include, for example, and without limitation, a camera 1610 and a microphone 1620. The camera 1610 may acquire an image frame, such as a still image or a moving picture, via an image sensor in a video call mode or a photography mode. An image captured via the image sensor may be processed by the processor 1300 or a separate image processor (not shown). According to an embodiment of the disclosure, the audio signal or video signal generated by the A/V input interface 1600 may be used as the one or more items of content for generating the text comment.

The microphone 1620 may receive an external audio signal and converts the external audio signal into electrical audio data. For example, the microphone 1620 may receive an audio signal from an external device or a speaking person. According to an embodiment of the disclosure, the audio signal received by the A/V input interface 1600 may be used as the one or more items of content for which the text comment is to be generated.

The memory 1700 may store a program used by the processor 1300 to perform processing and control and may also store data that is input to or output from the electronic device 1000. The memory 1700 according to an embodiment of the disclosure may store the one or more items of content for which the text comment is to be generated. The memory may also store feature information related to content.

The memory 1700 may include, for example, and without limitation, at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, an optical disk, or the like.

The programs stored in the memory 1700 may include various executable program elements and be classified into a plurality of modules according to their functions, for example, a user interface (UI) module 1710, a touch screen module 1720, and a notification module 1730.

The UI module 1710 may provide a UI, GUI, or the like that is specialized for each application and interoperates with the electronic device 1000. The touch screen module 1720 may detect a touch gesture on a touch screen of a user and transmit information regarding the touch gesture to the processor 1300. The touch screen module 1720 according to an embodiment of the disclosure may recognize and analyze a touch code. The touch screen module 1720 may be configured by separate hardware including a controller.

In order to detect an actual touch or a proximate touch on a touch screen, the touch screen may internally or externally have various sensors. An example of a sensor used to detect a touch on the touch screen is a tactile sensor. The tactile sensor denotes a sensor that detects a touch by a specific object to a degree to which a human feels or more. The tactile sensor may detect various types of information, such as the roughness of a touched surface, the hardness of the touching object, and the temperature of a touched point.

Examples of the touch gesture of the user may include, for example, and without limitation, tap, touch and hold, double tap, drag, panning, flick, drag and drop, swipe, and the like.

The notification module 1730 may generate a signal for notifying that an event has been generated in the electronic device 1000.

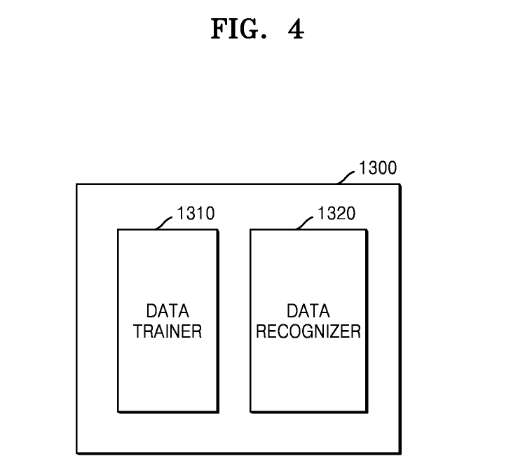

FIG. 4 is a block diagram illustrating an example of the processor 1300 according to an embodiment of the disclosure.

Referring to FIG. 4, the processor 1300 may include a data trainer (e.g., including processing circuitry and/or executable program elements) 1310 and a data recognizer (e.g., including processing circuitry and/or executable program elements) 1320.

The data trainer 1310 may include various processing circuitry and/or executable program elements and train a criterion for performing a text comment. The data trainer 1310 may train a criterion regarding what data is used to generate the text comment and how to generate the text comment using data. The data trainer 1310 may obtain data that is to be used in training, and may apply the obtained data to a data recognition model which will be described later, thereby training the criterion for generating the text comment.

The data recognizer 1320 may include various processing circuitry and/or executable program elements and generate the text comment, based on the data. The data recognizer 1320 may generate the text comment from certain data, using the trained data recognition model. The data recognizer 1320 may obtain certain data according to a criterion previously set due to training, and use a data recognition model using the obtained data as an input value, thereby generating the text comment based on the certain data. A result value output by the data recognition model using the obtained data as an input value may be used to update the data recognition model.

At least one of the data trainer 1310 and the data recognizer 1320 may be manufactured in the form of at least one hardware chip and may be mounted on an electronic device. For example, at least one of the data trainer 1310 and the data recognizer 1320 may be manufactured in the form of a dedicated hardware chip for artificial intelligence (AI), or may be manufactured as a portion of an existing general-purpose processor (for example, a central processing unit (CPU) or an application processor (AP)) or a processor dedicated to graphics (for example, a graphics processing unit (GPU)) and may be mounted on any of the aforementioned various electronic devices.

In this example, the data trainer 1310 and the data recognizer 1320 may be both mounted on a single electronic device, or may be respectively mounted on independent electronic devices. For example, one of the data trainer 1310 and the data recognizer 1320 may be included in an electronic device, and the other may be included in a server. The data trainer 1310 and the data recognizer 1320 may be connected to each other by wire or wirelessly, and thus model information established by the data trainer 1310 may be provided to the data recognizer 1320 and data input to the data recognizer 1320 may be provided as additional training data to the data trainer 1310.

At least one of the data trainer 1310 and the data recognizer 1320 may be implemented as a software module. When at least one of the data trainer 1310 and the data recognizer 1320 is implemented using a software module (or a program module including instructions), the software module may be stored in non-transitory computer readable media. In this case, the at least one software module may be provided by an operating system (OS) or by a certain application. Alternatively, some of the at least one software module may be provided by an OS and the others may be provided by a certain application.

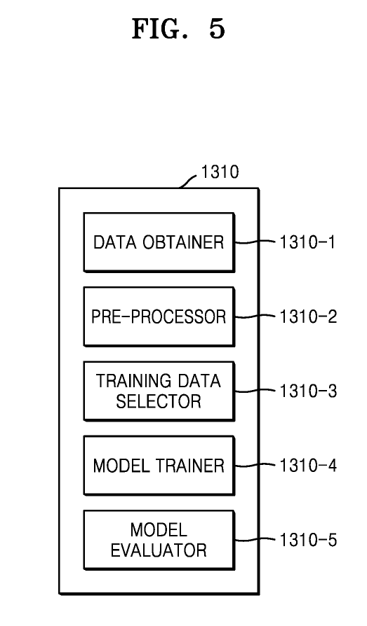

FIG. 5 is a block diagram illustrating an example of the data trainer 1310, according to an embodiment of the disclosure.

Referring to FIG. 5, the data trainer 1310 may include a data obtainer (e.g., including processing circuitry and/or executable program elements) 1310-1, a pre-processor (e.g., including processing circuitry and/or executable program elements) 1310-2, a training data selector (e.g., including processing circuitry and/or executable program elements) 1310-3, a model trainer (e.g., including processing circuitry and/or executable program elements) 1310-4, and a model evaluator (e.g., including processing circuitry and/or executable program elements) 1310-5.

The data obtainer 1310-1 may include various processing circuitry and/or executable program elements and obtain data necessary for generating a text comment. The data obtainer 1310-1 may obtain data necessary for training for generating a text comment.

The data obtainer 1310-1 may obtain information about the focus content 130 used to generate a text comment. The information about the focus content 130 may include the feature information of the focus content 130.

The data obtainer 1310-1 may obtain the feature information of the at least one item of content used to generate a text comment. Feature information of content may include at least one of information about an object included in the content, weather and location information, or action information of a user.

The data obtainer 1310-1 may obtain information about a text comment written by the user or another user.

The pre-processor 1310-2 may include various processing circuitry and/or executable program elements and pre-process obtained data such that the obtained data may be used in training for generating a text comment. The pre-processor 1310-2 may process the obtained data in a preset format such that the model trainer 1310-4, which will be described later, may use the obtained data for training for generating a text comment.

The training data selector 1310-3 may include various processing circuitry and/or executable program elements and select data necessary for training from among pieces of pre-processed data. The selected data may be provided to the model trainer 1310-4. The training data selector 1310-3 may select the data necessary for training from among the pieces of pre-processed data, according to a preset criterion for generating a text comment. The training data selector 1310-3 may select data according to a criterion previously set due to training by the model trainer 1310-4, which will be described later.

The model trainer 1310-4 may include various processing circuitry and/or executable program elements and train a criterion regarding how to generate a text comment, based on the training data. The model trainer 1310-4 may train a criterion regarding which training data is to be used to generate a text comment.

The model trainer 1310-4 may train a data recognition model for use in generation of a text comment, using the training data. In this example, the data recognition model may be a previously established model. For example, the data recognition model may be a model previously established by receiving basic training data (for example, a sample image).

The data recognition model may be established in consideration of, for example, an application field of a recognition model, a purpose of training, or computer performance of a device. The data recognition model may be, for example, a model based on a neural network. For example, a model, such as, for example, and without limitation, a deep neural network (DNN), a recurrent neural network (RNN), a bidirectional recurrent DNN (BRDNN), or the like, may be used as the data recognition model, but embodiments of the disclosure are not limited thereto.

According to various embodiments of the disclosure, when a plurality of data recognition models that are pre-established exist, the model trainer 1310-4 may determine a data recognition model having a high relationship between input training data and basic training data, as a data recognition model to be trained In this case, the basic training data may be pre-classified for each type of data, and the data recognition model may be pre-established for each type of data. For example, the basic training data may be pre-classified according to various standards such as an area where the training data is generated, a time for which the training data is generated, a size of the training data, a genre of the training data, a generator of the training data, and a type of an object in the training data

The model trainer 1310-4 may train the data recognition model using a training algorithm including, for example, error back-propagation or gradient descent.

The model trainer 1310-4 may train the data recognition model through supervised learning using, for example, the training data as an input value. The model trainer 1310-4 may train the data recognition model through unsupervised learning to find a criterion for situation determination, by self-training a type of data necessary for situation determination without supervision, for example. The model trainer 1310-4 may train the data recognition model through reinforcement learning using a feedback about whether a result of the situation determination according to training is right, for example.

When the data recognition model is trained, the model trainer 1310-4 may store the trained data recognition model. In this case, the model trainer 1310-4 may store the trained data recognition model in a memory of an electronic device including the data recognizer 1320. The model trainer 1310-4 may store the trained data recognition model in a memory of a server that is connected with the electronic device via a wired or wireless network.

In this example, the memory that stores the trained data recognition model may also store, for example, a command or data related to at least one other component of the electronic device 1000. The memory may also store software and/or a program. The program may include, for example, a kernel, a middleware, an application programming interface (API), and/or an application program (or an application).

When the model evaluator 1310-5 may include various processing circuitry and/or executable program elements and inputs evaluation data to the data recognition model and a recognition result that is output from the evaluation data does not satisfy a predetermined criterion, the model evaluator 1310-5 may enable the model trainer 1310-4 to train again. In this case, the evaluation data may be preset data for evaluating the data recognition model.

For example, when the number or percentage of pieces of evaluation data that provide inaccurate recognition results from among recognition results of the trained data recognition model with respect to the evaluation data exceeds a preset threshold, the model evaluator 1310-5 may evaluate that the predetermined criterion is not satisfied. For example, when the predetermined criterion is defined as 2% and the trained data recognition model outputs wrong recognition results for more than 20 pieces of evaluation data from among a total of 1000 pieces of evaluation data, the model evaluator 1310-5 may evaluate that the trained data recognition model is not appropriate.

When there are a plurality of trained data recognition models, the model evaluator 1310-5 may evaluate whether each of the plurality of trained data recognition models satisfies the predetermined criterion, and may determine, as a final data recognition model, a data recognition model that satisfies the predetermined criterion. In this case, when a plurality of models satisfy the predetermined criterion, the model evaluator 1310-5 may determine one or a predetermined number of models that are preset in a descending order of evaluation scores as final data recognition models.

At least one of the data obtainer 1310-1, the pre-processor 1310-2, the training data selector 1310-3, the model trainer 1310-4, or the model evaluator 1310-5 in the data trainer 1310 may be manufactured in the form of at least one hardware chip and may be mounted on an electronic device. For example, at least one of the data obtainer 1310-1, the pre-processor 1310-2, the training data selector 1310-3, the model trainer 1310-4, or the model evaluator 1310-5 may be manufactured in the form of a dedicated hardware chip for AI, or may be manufactured as a portion of an existing general-purpose processor (for example, a CPU or an AP) or a processor dedicated to graphics (for example, a GPU) and may be mounted on any of the aforementioned various electronic devices.

The data obtainer 1310-1, the pre-processor 1310-2, the training data selector 1310-3, the model trainer 1310-4, and the model evaluator 1310-5 may be all mounted on a single electronic device, or may be respectively mounted on independent electronic devices. For example, some of the data obtainer 1310-1, the pre-processor 1310-2, the training data selector 1310-3, the model trainer 1310-4, and the model evaluator 1310-5 may be included in an electronic device, and the others may be included in a server.

For example, at least one of the data obtainer 1310-1, the pre-processor 1310-2, the training data selector 1310-3, the model trainer 1310-4, or the model evaluator 1310-5 may be implemented as a software module. When at least one of the data obtainer 1310-1, the pre-processor 1310-2, the training data selector 1310-3, the model trainer 1310-4, or the model evaluator 1310-5 is implemented as a software module (or a program module including instructions), the software module may be stored in a non-transitory computer-readable recording medium. In this case, the at least one software module may be provided by an OS or by a certain application. Alternatively, some of the at least one software module may be provided by an OS and the others may be provided by a certain application.

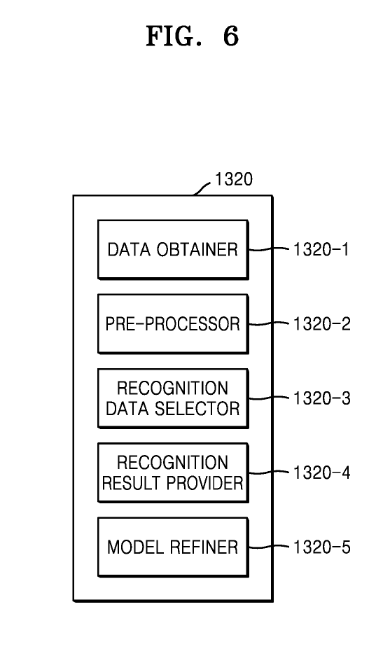

FIG. 6 is a block diagram illustrating an example of the data recognizer 1320, according to an embodiment of the disclosure.

Referring to FIG. 6, the data recognizer 1320 may include a data obtainer (e.g., including various processing circuitry and/or executable program elements) 1320-1, a pre-processor (e.g., including various processing circuitry and/or executable program elements) 1320-2, a recognition data selector (e.g., including various processing circuitry and/or executable program elements) 1320-3, a recognition result provider (e.g., including various processing circuitry and/or executable program elements) 1320-4, and a model refiner (e.g., including various processing circuitry and/or executable program elements) 1320-5.

The data obtainer 1320-1 may include various processing circuitry and/or executable program elements and obtain data necessary for generating a text comment, and the pre-processor 1320-2 may include various processing circuitry and/or executable program elements and pre-process the obtained data such that the obtained data may be used to generate a text comment. The pre-processor 1320-2 may process the obtained data in a preset format such that the recognition result provider 1320-4, which will be described later, may use the obtained data to generate a text comment.

The recognition data selector 1320-3 may include various processing circuitry and/or executable program elements and select data necessary for generating a text comment, from among the pre-processed data. The selected data may be provided to the recognition result provider 1320-4. The recognition data selector 1320-3 may select some or all of the pre-processed data, according to a preset criterion for generating a text comment. The recognition data selector 1320-3 may select data according to a criterion previously set due to training by the model trainer 1310-4.

The recognition result provider 1320-4 may include various processing circuitry and/or executable program elements and generate a text comment by applying the selected data to the data recognition model. The recognition result provider 1320-4 may provide the text comment as a recognition result that conforms to a data recognition purpose. The recognition result provider 1320-4 may apply the selected data to the data recognition model using the data selected by the recognition data selector 1320-3 as an input value. The recognition result may be determined by the data recognition model.

The model refiner 1320-5 may include various processing circuitry and/or executable program elements and enable the data recognition model to be refined, based on an evaluation of a recognition result provided by the recognition result provider 1320-4. For example, the model refiner 1320-5 may enable the model trainer 1310-4 to refine the data recognition model, by providing the recognition result provided by the recognition result provider 1320-4 to the model trainer 1310-4.

At least one of the data obtainer 1320-1, the pre-processor 1320-2, the recognition data selector 1320-3, the recognition result provider 1320-4, and/or the model refiner 1320-5 within the data recognizer 1320 may be manufactured in the form of at least one hardware chip and may be mounted on an electronic device. For example, at least one of the data obtainer 1320-1, the pre-processor 1320-2, the recognition data selector 1320-3, the recognition result provider 1320-4, or the model refiner 1320-5 may be manufactured in the form of a dedicated hardware chip for AI, or may be manufactured as a portion of an existing general-purpose processor (for example, a CPU or an AP) or a processor dedicated to graphics (for example, a GPU) and may be mounted on any of the aforementioned various electronic devices.

The data obtainer 1320-1, the pre-processor 1320-2, the recognition data selector 1320-3, the recognition result provider 1320-4, and the model refiner 1320-5 may be all mounted on a single electronic device, or may be respectively mounted on independent electronic devices. For example, some of the data obtainer 1320-1, the pre-processor 1320-2, the recognition data selector 1320-3, the recognition result provider 1320-4, and the model refiner 1320-5 may be included in an electronic device, and the others may be included in a server.

At least one of the data obtainer 1320-1, the pre-processor 1320-2, the recognition data selector 1320-3, the recognition result provider 1320-4, or the model refiner 1320-5 may be implemented as a software module. When at least one of the data obtainer 1320-1, the pre-processor 1320-2, the recognition data selector 1320-3, the recognition result provider 1320-4, or the model refiner 1320-5 is implemented as a software module (or a program module including instructions), the software module may be stored in a non-transitory computer-readable recording medium. In this case, the at least one software module may be provided by an OS or by a certain application. Alternatively, some of the at least one software module may be provided by an OS and the others may be provided by a certain application.

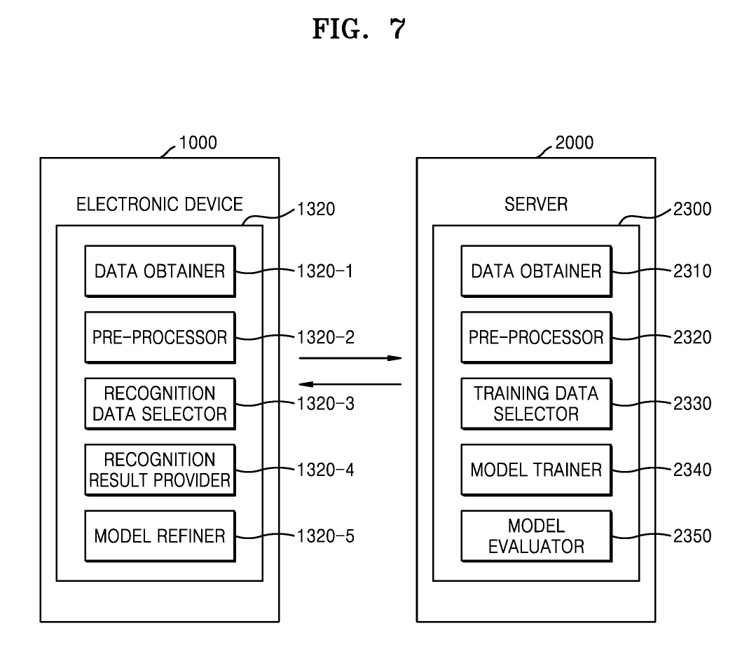

FIG. 7 is a block diagram illustrating an example where the electronic device 1000 and a server 2000 interoperate to train and recognize data, according to various example embodiments of the disclosure.

Referring to FIG. 7, the server 2000 may train a criterion for generating a text comment, and the electronic device 1000 may generate the text comment, based on a result of the training performed by the server 2000. It will be understood that the names of the various elements illustrated in FIG. 7 may be the same as or similar to those described above with reference to FIGS. 5 and 6. Therefore, repeated descriptions thereof may not be repeated here for convenience and ease of understanding.

In this case, a model trainer 2340 of the server 2000 may perform a function of the data trainer 1310 of FIG. 5. The model trainer 2340 of the server 2000 may train a criterion regarding what data is used to generate the text comment and how to generate the text comment using data. The data trainer 2340 may obtain data that is to be used in training, and may apply the obtained data to a data recognition model which will be described later, thereby training the criterion for generating the text comment.

The recognition result provider 1320-4 of the electronic device 1000 may apply the data selected by the recognition data selector 1320-3 to a data recognition model generated by the server 2000, thereby generating the text comment. For example, the recognition result provider 1320-4 may transmit the data selected by the recognition data selector 1320-3 to the server 2000, and the server 2000 may request generation of the text comment by applying the data selected by the recognition data selector 1320-3 to a data recognition model. The recognition result provider 1320-4 may receive information about a text comment generated by the server 2000 from the server 2000.

The recognition result provider 1320-4 of the electronic device 1000 may receive the data recognition model generated by the server 2000 from the server 2000, and may generate the text comment using the received data recognition model. In this case, the recognition result provider 1320-4 of the electronic device 1000 may generate the text comment by applying the data selected by the recognition data selector 1320-3 to the data recognition model received from the server 2000.

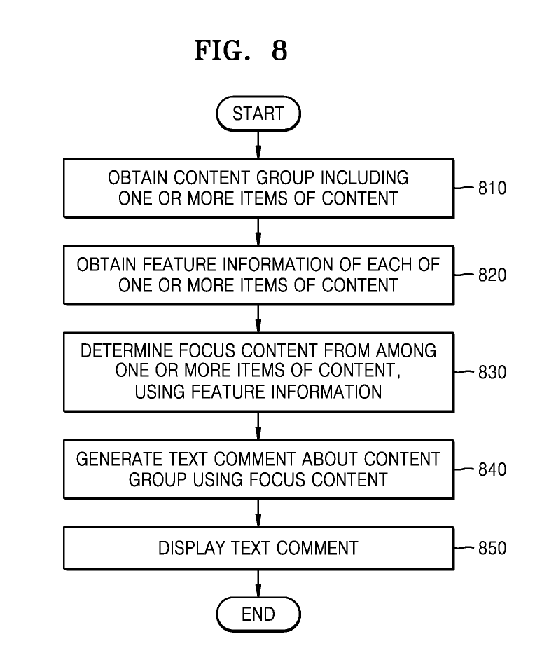

FIG. 8 is a flowchart illustrating an example method of automatically generating a text comment about content, according to an embodiment of the disclosure.

Referring to FIG. 8, in operation 810, the electronic device 1000 may obtain a content group including one or more items of content for generating a text comment. According to an embodiment of the disclosure, the one or more items of content for generating a text comment may be selected based on a user input.

According to another embodiment of the disclosure, when at least one picture or moving picture is captured and generated, the electronic device 1000 may automatically generate a text comment by obtaining at least one currently captured picture or moving picture without a special input of the user, according to a behavior pattern of the user.

When an SNS notice is written when a picture including food is captured, the electronic device 1000 may automatically generate the text comment according to a picture capturing pattern of the user. When the electronic device 1000 captures a picture including food based on a user input, the electronic device 1000 may automatically generate and display a text comment about at least one food picture without a user input for generating a text comment. The user may check the automatically generated text comment, and, as necessary, may correct the automatically generated text comment. The electronic device 1000 may write an SNS notice using the automatically generated text comment, based on a user input.

In operation 820, the electronic device 1000 may obtain feature information of each of the one or more items of content obtained in operation 810. According to an embodiment of the disclosure, the feature information may include at least one of information about an object included in the content, weather and a location related to the content, or information about the user.

The feature information of content according to an embodiment of the disclosure may be obtained by analyzing the content, but embodiments of the disclosure are not limited thereto. The feature information of the content may be obtained based on information obtained via various methods, such as user data or information searchable from the Internet.

In operation 830, the electronic device 1000 may determine focus content from among the one or more items of content, using the feature information obtained in operation 820. According to an embodiment of the disclosure, based on the feature information of the content, content capable of representing the one or more items of content may be determined as focus content. According to an embodiment of the disclosure, the electronic device 1000 may determine the focus content, based on a machine learning algorithm for selecting the focus content. However, embodiments of the disclosure are not limited thereto, and the focus content may be determined according to various methods.

In operation 840, the electronic device 1000 may generate a text comment about the content group using the focus content determined in operation 830. According to an embodiment of the disclosure, the electronic device 1000 may generate a text comment by obtaining a text template, based on the feature information of the focus content, and inserting the feature information of the focus content into the text template.

According to an embodiment of the disclosure, the electronic device 1000 may generate a text comment about the one or more items of content, based on a text comment about other content including feature information that is the same as or similar to the feature information of the focus content.

For example, when the focus content is a picture including food, the electronic device 1000 may generate a text comment using a text about other content related to food. For example, the electronic device 1000 may search for a notice including ‘food’, ‘famous restaurant’, and ‘dish’ as hash tags, from among notices uploaded on SNSs. The electronic device 1000 may generate the text comment about the one or more items of content using structures of found SNS notices and words included in the found SNS notices.

In operation 850, the electronic device 1000 may display the text comment generated in operation 840. Based on a user input, the electronic device 1000 may write an SNS message, an E-mail message, an SNS notice, and the like using the generated text comment, and transmit the written SNS message, the written E-mail message, the written SNS notice, and the like to an external device.

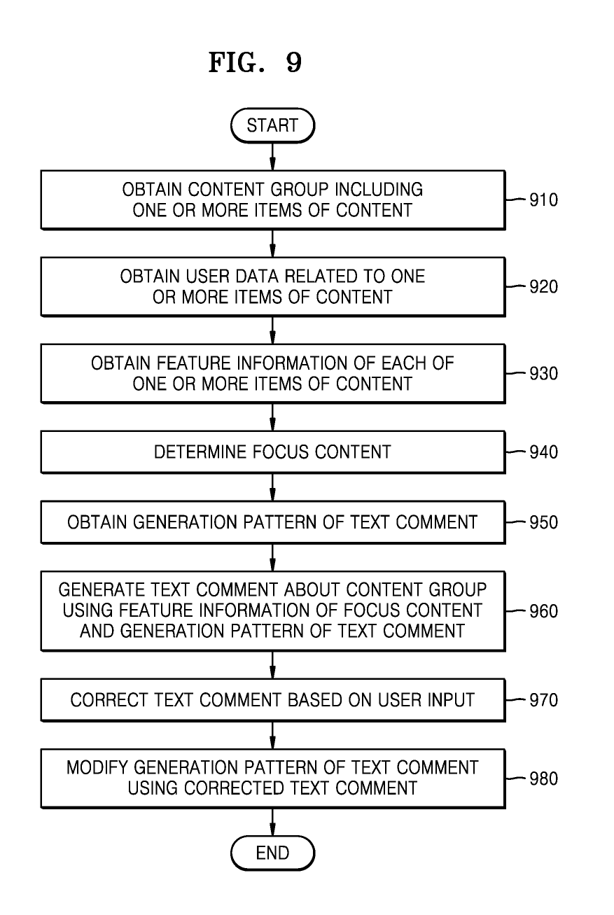

FIG. 9 is a flowchart illustrating an example method of generating a text comment about content, according to an embodiment of the disclosure. The method of FIG. 9 corresponds to the method of FIG. 8, and thus redundant descriptions thereof may not be repeated here.

Referring to FIG. 9, in operation 910, the electronic device 1000 may obtain a content group including one or more items of content for generating a text comment.

In operation 920, the electronic device 1000 may obtain user data related to the one or more items of content. The user data may include not only information related to a user, such as a surrounding environment of the user, surrounding people thereof, and a life pattern thereof, but also information about people, objects, and animals related to the user of the electronic device 1000.

In operation 930, the electronic device 1000 may obtain feature information of each of the one or more items of content obtained in operation 910. According to an embodiment of the disclosure, the electronic device 1000 may generate the feature information of each content using the user data related to each content obtained in operation 920. For example, when one person from among the family members of the user is recognized as an object in content, the electronic device 1000 may obtain a title (e.g., my daughter, a son, and my mother) of the recognized object as the feature information of the content, based on the user data.

In operation 940, the electronic device 1000 may determine focus content from among the one or more items of content, using the feature information of each of the one or more items of content. For example, content including many pieces of feature information highly related to the central theme of a text comment may be determined as the focus content. The central theme may be determined based on a user input or may be determined based on the feature information of each of the one or more items of content.

In operation 950, the electronic device 1000 may obtain a generation pattern of the text comment. The generation pattern of the text comment may be previously trained based on a text generated by the user of the electronic device 1000. The generation pattern of the text comment is not limited to the user of the electronic device 1000, and thus the generation pattern of the text comment may be previously trained based on a text generated by another user.

In operation 960, the electronic device 1000 may generate a text comment about the content group obtained in operation 910, using the feature information of the focus content and the generation pattern of the text comment.

In operation 970, the electronic device 1000 may correct the text comment generated in operation 960, based on a user input, as necessary. The electronic device 1000 may write an SNS notice or message using the text comment corrected by the user, based on a user input.

In operation 980, the electronic device 1000 may modify the generation pattern of the text comment about the user, using the text comment corrected by the user. The modified generation pattern of the text comment may be used to automatically generate a text comment according to an embodiment of the disclosure.

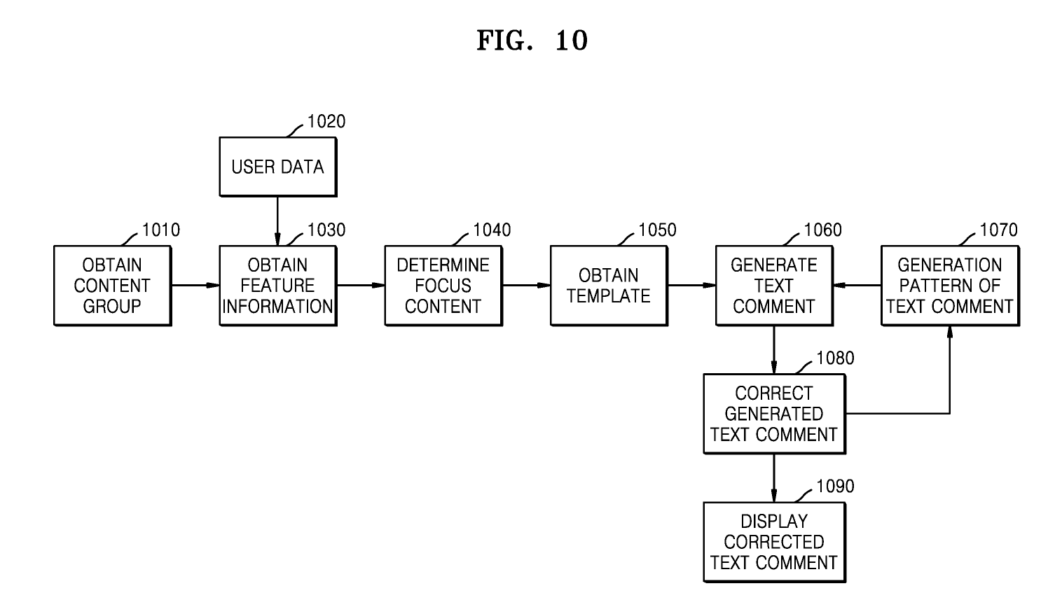

FIG. 10 is a block diagram illustrating an example method of generating a text comment about content, according to an embodiment of the disclosure. The method of FIG. 10 corresponds to the methods of FIGS. 8 and 9, and thus redundant descriptions thereof may not be repeated here.

Referring to FIG. 10, in block 1010, the electronic device 1000 may obtain a content group including one or more items of content. In block 1020, an electronic device 1000 may obtain user data for generating a text comment. The user data may include various pieces of information related to a user, such as life log information of the user, ID information thereof, and ID information of surrounding people and surrounding objects of the user.

In block 1030, the electronic device 1000 may obtain feature information of each of the one or more items of content, using the user data. The feature information of each content may be obtained using not only information obtained based on a result of analyzing the content but also user data including information about the user.

In block 1040, the electronic device 1000 may determine focus content from among the one or more items of content, using the feature information of each of the one or more items of content.

In block 1050, the electronic device 1000 may obtain a template into which a text is insertable, based on the feature information of the focus content.

In block 1060, the electronic device 1000 may generate a text comment about the content group obtained in block 1010, using the template and the generation pattern of the text comment, based on the feature information of the focus content.

In block 1070, the electronic device 1000 may obtain a generation pattern of the text comment. The generation pattern of the text comment may be obtained by training a text generated by the user of the electronic device 1000.

In block 1080, the electronic device 1000 may correct the automatically generated text comment, based on a user input. When the text comment is corrected based on a user input, the electronic device 1000 may modify the generation pattern of the text comment using the corrected text comment.

In block 1090, the electronic device 1000 may display the corrected text comment, based on a user input.

According to an embodiment of the disclosure, the text comment may be generated according to duplicate or consistent feature information by being generated based on the focus content determined from among one or more items of content.

According to an embodiment of the disclosure, a text comment is generated based on focus content determined from among one or more items of content, and thus the text comment may be generated according to neither overlapping nor contradictory feature information.

According to an embodiment of the disclosure, a text comment including a personalized and detailed expression may be generated by utilizing not only information obtainable as a result of an analysis of content but also information obtained via various methods, such as personal information of a user or information searchable on the Internet.

An embodiment of the disclosure can also be embodied as a storage medium including instruction codes executable by a computer such as a program module executed by the computer. A computer readable medium can be any available medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, or the program module, and includes any information transmission medium.

The terminology “˜unit” used herein may be a hardware component such as a processor or a circuit, and/or a software component and/or any combinations thereof that is executed by a hardware component such as a processor.

Although various example embodiments of the disclosure have been described for illustrative purposes, one of ordinary skill in the art will appreciate that diverse variations and modifications are possible, without departing from the spirit and scope of the disclosure. Thus, the above example embodiments of the disclosure should be understood not to be restrictive but to be illustrative, in all aspects. For example, respective elements described in an integrated form may be dividedly used, and the divided elements may be used in a state of being combined.

While one or more example embodiments of the disclosure have been described with reference to the figures, it will be understood by those of ordinary skill in the art that various changes in form and details may be made therein without departing from the spirit and scope as defined, for example, by the following claims and their equivalents.

What is claimed is:

1. A method of generating a text comment about content, the method comprising:
obtaining a content group including one or more items of content;
obtaining feature information of each of the one or more items of content;
determining focus content from among the one or more items of content using the obtained feature information;
generating a text comment about the content group using the focus content; and
displaying the generated text comment.

2. The method of claim 1, wherein the generating of the text comment comprises generating the text comment about the content group using feature information of the focus content.

3. The method of claim 1, wherein the generating of the text comment comprises:
determining first content having feature information overlapping with, or contradictory to, feature information of the focus content from among the one or more items of content; and
generating the text comment about the content group by further using second content other than the first content from among the one or more items of content in addition to the first content.

4. The method of claim 1, wherein the feature information of each of the one or more items of content comprises at least one of: information about an object included in each of the one or more items of content, weather and a location related to each of the one or more items of content, and/or information about a user.

5. The method of claim 1, wherein the obtaining of the feature information comprises:
recognizing an object included in each of the one or more items of content; and
obtaining information about the object, the information including at least one of: identification information of the object, location information of the object, information about a state of the object, and/or information about features of the object.

6. The method of claim 5, wherein the recognizing of the object comprises:
obtaining location information corresponding to the one or more items of content; and
recognizing an object included in each of the one or more items of content based on the location information.

7. The method of claim 1, wherein the generating of the text comment comprises:
obtaining feature information corresponding to the focus content;
obtaining a text template based on the feature information of the focus content; and
generating the text comment using the feature information of the focus content and the text template.

8. An electronic device for generating a text comment about content, the electronic device comprising:
a processor configured to control the electronic device to: obtain a content group comprising one or more items of content, obtain feature information of each of the one or more items, determine focus content from among the one or more items of content using the obtained feature information, and generate a text comment about the content group using the focus content; and
a display displaying the generated text comment.

9. The electronic device of claim 8, wherein the processor is further configured to control the electronic device to generate the text comment about the content group using feature information of the focus content.

10. The electronic device of claim 8, wherein the processor is further configured to control the electronic device to: generate the text comment about the content group by determining first content including feature information overlapping with, or contradictory to, feature information of the focus content from among the one or more items of content and further using second content other than the first content from among the one or more items of content in addition to the first content.

11. The electronic device of claim 8, wherein the feature information of each of the one or more items of content comprises at least one of: information about an object included in each of the one or more items of content, weather and a location related to each of the one or more items of content, and/or information about a user.

12. The electronic device of claim 8, wherein the processor is further configured to control the electronic device to: recognize an object included in each of the one or more items of content, and obtain information about the object, the information including at least one of: identification information of the object, location information of the object, information about a state of the object, and/or information about features of the object.

13. The electronic device of claim 12, wherein the processor is further configured to control the electronic device to: obtain location information corresponding to each of the one or more items of content and recognize an object included in each of the one or more items of content.

14. The electronic device of claim 8, wherein the processor is further configured to control the electronic device to: obtain feature information corresponding to the focus content, obtain a text template based on the feature information of the focus content, and generate the text comment using the feature information of the focus content and the text template.

15. A non-transitory computer-readable recording medium having recorded thereon a computer program, which, when executed by a computer, performs the method of claim 1.
